(19) United States
(12) Patent Application Publication
(10) Pub. No.: US 2010/0031470 A1
(43) Pub. Date: Feb. 11, 2010

(54) HINGE AND HINGE SYSTEM

(75) Inventors: Brent Lee Bucks, Lakewood Ranch, FL (US); Stuart Allan Tyson, Bradenton, FL (US); Michael James Bryant, Bradenton, FL (US)

Correspondence Address: BARNES & THORNBURG LLP, 750-17TH STREET NW, SUITE 900, WASHINGTON, DC, 20006-4675, US

(73) Assignee: Ameritex Technologies, Inc., East Bradenton, FL (US)

(21) Appl. No.: 12/189,569

(22) Filed: Aug. 11, 2008

(51) Int. Cl. E05D 7/00

(52) U.S. Cl. 16/224

(57) ABSTRACT

A hinge is described that includes a first bracket adapted to be attached to a first substrate. The first bracket includes a channel defining a first central axis and defining a first lateral axis perpendicular to the first central axis. The hinge also includes a second bracket adapted to be attached to a second substrate. The second bracket defines a second central axis and a second lateral axis perpendicular to the second central axis. The first lateral axis and the second lateral axis are disposed a distance from one another. A connecting stem pivotally connects the first bracket to the second bracket. A protrusion is disposed at one end of the connecting stem. The protrusion is disposed within the channel defined by the first bracket. An adjustable connection exists between the connecting stem and the second bracket to permit adjustment of the distance between the first and second lateral axes.

### CROSS-REFERENCE TO RELATED APPLICATION(S)

This U.S. patent application is a first-filed patent application and does not rely on any other patent application for priority.

### FIELD OF THE INVENTION

The invention described herein relates to a hinge. More specifically, the invention concerns a hinge based on a ball and socket design that provides flexibility in installation.

### DISCUSSION OF RELATED ART

The use of hinges is widespread.

Perhaps the most common type of hinge is a pin-pivoted hinge. This hinge is commonly employed for doors. The design of the hinge includes two plates that are pivotally mounted with respect to one another around a common pin axis. The two plates are interleaved to take advantage of the common pin axis.

As should be appreciated by those skilled in the art, it is common to employ two or three hinges on a standard door to properly support the weight of the door.

In order for the hinges to permit the door to open smoothly, the axes of the individual hinges must be aligned with one another. If the axes are not aligned, the operation of the hinges will interfere with one another, with any number of adverse effects.

This difficulty with hinges is particularly pronounced when installing doors or similar items that include a curved (non-linear) surface or profile. As noted above, if the axes of the hinges are not properly aligned, the door will not open properly (or at all, in some instances).

As also may be appreciated, boats and other watercraft present a particular challenge to the typical carpenter installing a hinge. While not limited to the marine environment, it is not uncommon on boats to have doors that are not planar.

Non-planar doors may be used to separate passenger areas from one another, for example. Where curved doors are used, the challenge to align the axes of traditional hinges is increased.

In the construction industry, it is not uncommon for door sills and frames to be exactly square each and every time that the door sill or frame is manufactured. This introduces a reliability factor into construction items that minimizes the possibility of hinge axis misalignment.

As should be appreciated by carpenters, builders, etc., this is not always the case. There are a number of instances where a particular circumstance differs from a prior example. Traditional pin-pivoted hinges do not lend themselves well to non-traditional environments.

In the case of watercraft and boats, the issue of dimensional inexactness does arise from time to time. While each boat will be essentially the same as a boat that precedes it in a particular model line, the boat molding process has a tendency to introduce variations from one boat deck to another. As a result, while a traditional pin-pivoted hinge may be perfectly suitable for one boat in a production series, a subsequent boat may present unforeseen challenges to a door installer.

As a result of at least some of these factors, a need has arisen for a hinge that is more adaptable than a standard pin-pivoted hinge.

### SUMMARY OF THE INVENTION

It is, therefore, an aspect of the invention to resolve one or more of the deficiencies noted with respect to the prior art.

For example, it is an aspect of the invention to provide a hinge that does not rely on a pin-pivoted construction.

The invention also provides a hinge that may be combined with one or more other hinges to form a hinge system.

The hinge of the invention permits smooth opening of a door or other hinged structure even if the axes of individual hinges are not aligned with one another.

The invention provides a hinge that may be used to mount non-linear or non-planar substrates and surfaces. For example, the hinge of the invention may be employed to mount a curved door.

The hinge of the invention may be employed in, for example, a boat. In one contemplated embodiment, the hinge of the invention may be employed to mount a door separating passenger areas in a boat. Other doors, such as cabinet doors, also may benefit from the hinge of the application.

The invention provides a hinge that reduces challenges when aligning the axes of individual ones of the hinges, especially when two or more are employed in concert with one another.

The hinge of the invention provides for greater flexibility in installation. For example, with respect to boats where variations may occur between individual ones of a particular model, the hinge of the invention permits flexibility to accommodate those variations.

The hinge of the invention facilitates installation by permitting two or more hinges to be mounted without precise axial alignment, from many different axial perspectives.

While not intended to be limiting of the invention, in one embodiment, the hinge includes a first bracket adapted to be attached to a first substrate. The first bracket has a channel defining a first central axis and defining a first lateral axis perpendicular to the first central axis. The hinge also includes a second bracket adapted to be attached to a second substrate. The second bracket defines a second central axis and a second lateral axis perpendicular to the second central axis. The first lateral axis and the second lateral axis are disposed a distance from one another. A connecting stem pivotally connects the first bracket to the second bracket. A protrusion is disposed at one end of the connecting stem. The protrusion is disposed within the channel defined by the first bracket. An adjustable connection exists between the connecting stem and the second bracket. The adjustable connection permits adjustment of the distance between the first and the second lateral axes.

While not intended to be limiting of the broad scope of the invention, it is contemplated that the first central axis and the second central axis of the hinge will be co-linear, at least in one embodiment.

Alternatively, the invention is contemplated to encompass a hinge where the first central axis and the second central axis are angled with respect to one another.

With respect to the first bracket, it is contemplated that the bracket will include two upwardly extending arms that define the channel therebetween.

The hinge also may include an insert disposed within the channel to facilitate movement of the protrusion within the channel.

The protrusion may be retained within an indentation formed in the insert.

A retainer may be provided to affix the insert within the channel.

The insert may be made from polytetrafluoroethylene, among other materials.

In one contemplated embodiment, the protrusion may be spherical. Of course, other shapes also may be employed.

With respect to embodiments of the invention, the second bracket may include a threaded portion and the adjustable connection may include a threaded end on the connecting stem that engages the threaded portion of the second bracket.

A locking member may be provided that retains the connecting stem to maintain the distance between the first and the second lateral axes.

It is also contemplated that the hinge of the invention will be used in a hinge system.

One contemplated embodiment of a hinge system includes a first and a second hinge, although several hinges may be employed together.

Where at least first and second hinges are employed in a system, it is contemplated that the first hinge will include a first bracket adapted to be attached to a first substrate. The first bracket may have a first channel defining a first central axis and defining a first lateral axis perpendicular to the first central axis. The first hinge also may include a second bracket adapted to be attached to a second substrate, the second bracket defining a second central axis and a second lateral axis perpendicular to the second central axis, wherein the first lateral axis and the second lateral axis are disposed a first distance from one another. A first connecting stem may pivotally connect the first bracket to the second bracket. A first protrusion may be disposed at one end of the first connecting stem, the first protrusion being disposed within the first channel defined by the first bracket. A first adjustable connection may be established between the first connecting stem and the second bracket. In such a case, the first adjustable connection may permit adjustment of the first distance between the first and the second lateral axes. In this system, the second hinge may include a third bracket adapted to be attached to the first substrate. The third bracket may have a second channel defining a third central axis and defining a third lateral axis perpendicular to the third central axis. The second hinge also may include a fourth bracket adapted to be attached to a second substrate. The fourth bracket may define a fourth central axis and a fourth lateral axis perpendicular to the fourth central axis. The third lateral axis and the fourth lateral axis may be disposed a second distance from one another. The second hinge also may include a second connecting stem pivotally connecting the third bracket to the fourth bracket and a second protrusion disposed at one end of the second connecting stem. If so, the second protrusion may be disposed within the second channel defined by the third bracket. A second adjustable connection may be established between the second connecting stem and the fourth bracket. The second adjustable connection may permit adjustment of the second distance between the third and the fourth axes. The first hinge and the second hinge may be disposed a third distance from one another.

In a hinge system, at least one of the first central axis may be angled with respect to the second central or the third central axis may be angled with respect to the fourth central axis.

It is contemplated that the hinge system may include a construction where the first distance does not equal the second distance.

It is also contemplated that the hinge system may accommodate circumstances where at least one of the first and second substrates defines a non-linear surface.

Alternatively, the hinge system may accommodate, among other arrangements, circumstances where at least one of the first and second substrates defines a curved surface.

It is also contemplated that one or more embodiments of the invention will encompass a hinge that has a first bracket adapted to be attached to a first substrate. The first bracket may have a first channel defining a first central axis and defining a first lateral axis perpendicular to the first central axis. The hinge also may include a second bracket adapted to be attached to a second substrate. The second bracket may have a second channel defining a second central axis and defining a second lateral axis perpendicular to the second central axis. A connecting stem may pivotally connect the first bracket to the second bracket. A first protrusion may be adjustably disposed on a first end of the connecting stem, the first protrusion being retained within the first channel. A second protrusion may be adjustably disposed on a second end of the connecting stem, the second protrusion being retained within the second channel. It is contemplated that adjustment of one or both of the first and second protrusions on the connecting stem adjusts a distance between the first lateral axis and the second lateral axis.

It is also contemplated, with respect to this embodiment, that the invention provides a hinge where the first lateral axis and the second lateral axis are angled with respect to one another when the hinge is installed for operation.

The invention also encompasses, among other things, a hinge system with at least first and second hinges. In this system, the first hinge may include a first bracket adapted to be attached to a first substrate, the first bracket having a first channel defining a first central axis and defining a first lateral axis perpendicular to the first central axis. The first hinge also may include a second bracket adapted to be attached to a second substrate, the second bracket having a second channel defining a second central axis and defining a second lateral axis perpendicular to the second central axis. A first connecting stem may pivotally connect the first bracket to the second bracket. A first protrusion may be adjustably disposed on a first end of the first connecting stem, the first protrusion being retained within the first channel. A second protrusion may be adjustably disposed on a second end of the first connecting stem, the second protrusion being retained within the second channel. Similarly, the second hinge may include a third bracket adapted to be attached to the first substrate. The third bracket may have a third channel defining a third central axis and defining a third lateral axis perpendicular to the third central axis. The second hinge also may include a fourth bracket adapted to be attached to the second substrate. The fourth bracket may have a fourth channel defining a fourth central axis and defining a fourth lateral axis perpendicular to the fourth central axis. The second hinge may have a second connecting stem pivotally connecting the third bracket to the fourth bracket. A third protrusion may be adjustably disposed on a first end of the second connecting stem, the third protrusion being retained within the third channel. A fourth protrusion may be adjustably disposed on a second end of the second connecting stem, the fourth protrusion being retained within the fourth channel. Adjustment of one or both of the first and second protrusions on the first connecting stem may be used to adjust a first distance between the first lateral axis and the second lateral axis. Adjustment of one or both of the third and fourth protrusions on the second connecting stem may adjust a second distance between the third lateral axis and the fourth lateral axis.

In this contemplated hinge system, at least one of the first and second substrates may define a non-linear surface. Although not limiting of the invention, at least one of the first and second substrates defines a curved surface.

In this hinge system, it is contemplated that the first and second connecting stems may be oriented other than parallel to one another.

Other aspects of the invention will be made apparent from the discussion that follows.

### BRIEF DESCRIPTION OF THE DRAWINGS

The invention will now be described in connection with several figures of drawings, in which:

FIG. 1 is perspective, top view of a hinge according to the invention, shown from a front side of the hinge;

FIG. 2 is a perspective, top view of the hinge illustrated in FIG. 1, shown from a rear side of the hinge;

FIG. 3 is an elevational side view of the hinge shown in FIG. 1;

FIG. 4 is an elevational front view of the hinge depicted in FIG. 1;

FIG. 5 is a top plan view of the hinge shown in FIG. 1;

FIG. 6 is an elevational rear view of the hinge illustrated in FIG. 1;

FIG. 7 is a perspective, exploded view of the hinge depicted in FIG. 1, showing the various elements and features contributing to the invention;

FIG. 8 is a top plan view of the hinge shown in FIG. 1, illustrating the hinge when configured for a wide distance between the first and second brackets;

FIG. 9 is a side elevational view of the hinge shown in FIG. 8, illustrating the hinge when configured for a wide distance between the first and second brackets;

FIG. 10 is a top plan view of the hinge shown in FIG. 1, illustrating the hinge when configured for a medium distance between the first and second brackets;

FIG. 11 is a side elevational view of the hinge shown in FIG. 10, illustrating the hinge when configured for a medium distance between the first and second brackets;

FIG. 12 is a top plan view of the hinge shown in FIG. 1, illustrating the hinge when configured for a narrow distance between the first and second brackets;

FIG. 13 is a side elevational view of the hinge shown in FIG. 12, illustrating the hinge when configured for a narrow distance between the first and second brackets;

FIG. 14 is a side elevational view of the hinge illustrated in FIG. 1, showing a full rotation of the hinge;

FIG. 15 is a perspective illustration of the hinge depicted in FIG. 1, shown in a first position before rotation of the hinge;

FIG. 16 is a perspective illustration of the hinge illustrated in FIG. 1, shown in a second position, which is about one half of the rotation of the hinge;

FIG. 17 is a perspective illustration of the hinge illustrated in FIG. 1, shown in a third position, which is the full rotation of the hinge;

FIG. 18 is a top plan view of three of the hinges shown in FIG. 1, aligned along a common axis with respect to the ball joint, but unequally distributed with respect to the second brackets of each;

FIG. 19 illustrates a pair of the hinges according to the invention, shown in one possible orientation;

FIG. 20 is a top plan view of two of the hinges according to the invention, shown in an orientation where the pivoted structure is not planar;

FIG. 21 is an elevational view of the hinges illustrated in FIG. 20, shown after the pivoted structure has been rotated through 90°;

FIG. 22 is a top plan view of the hinges illustrated in FIG. 21, shown after the pivoted structure has been rotated through 180°;

FIG. 23 is a perspective illustration of two hinges employed to establish a pivot for the pivoted structure; and

FIG. 24 illustrates a second embodiment of a hinge according to the invention, in this case where the hinge includes two spherical protrusions.

### DESCRIPTION OF PREFERRED EMBODIMENT(S) OF THE INVENTION

While the invention is described in connection with several embodiments, as enumerated below and as illustrated herein, the invention is not intended to be limited solely to the embodiments provided. To the contrary, the embodiments emphasized are intended merely to be illustrative of selected examples that fall within the broad scope of the subject matter of the invention.

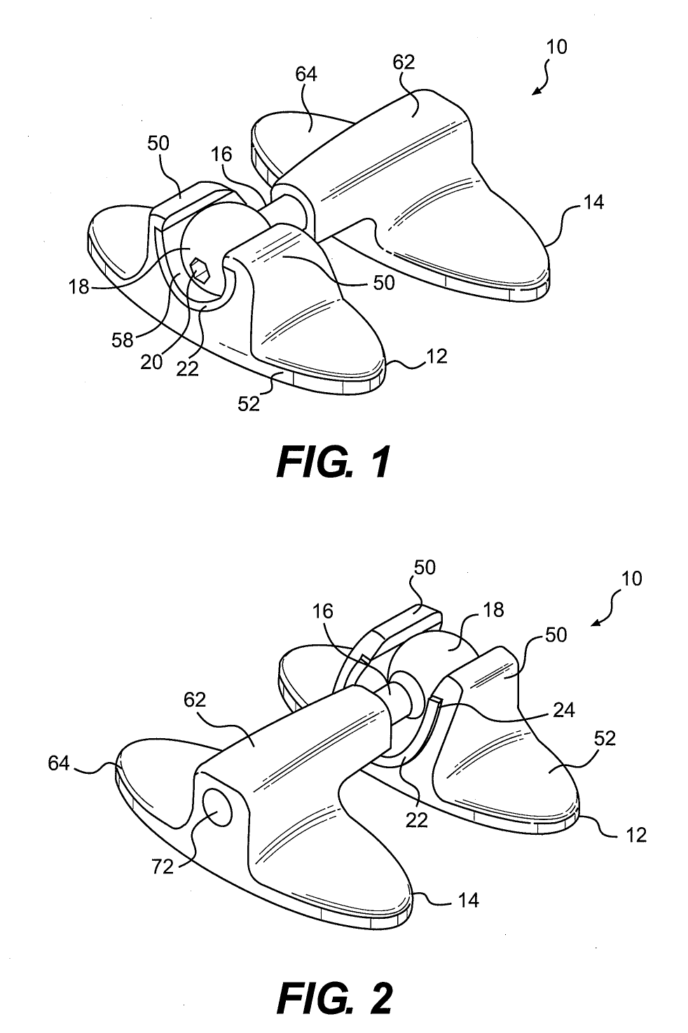

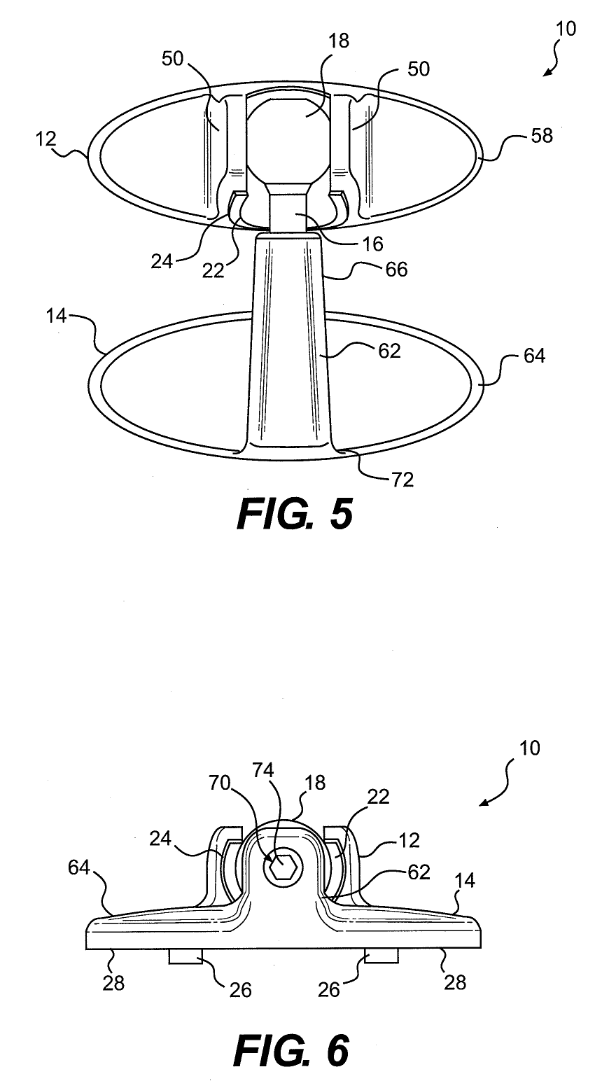

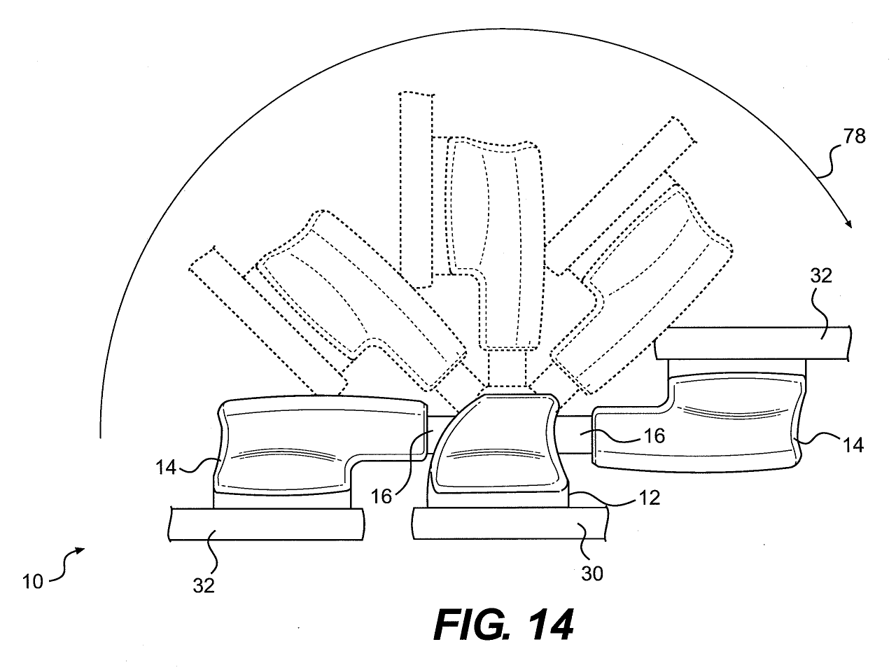

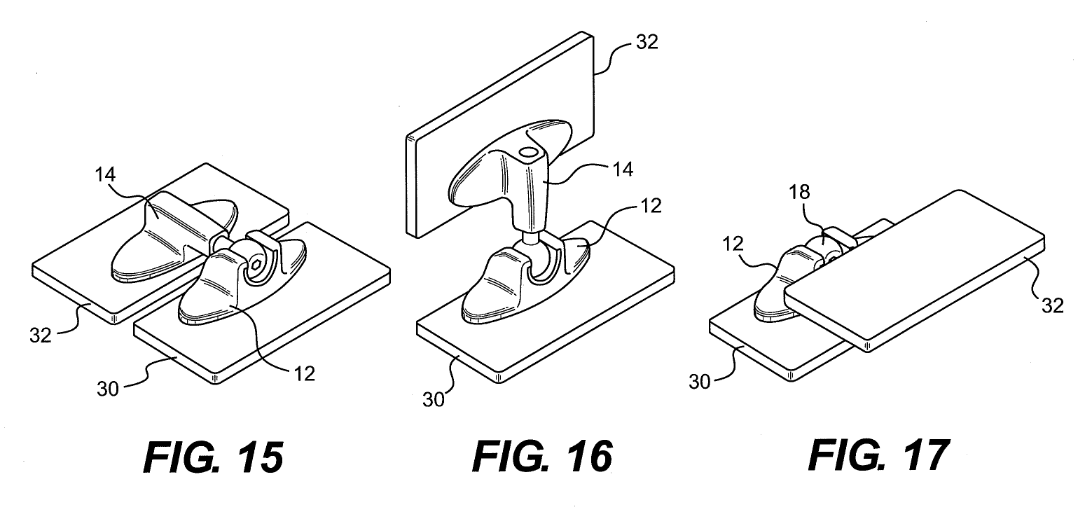

FIGS. 1-6 provide several views of a hinge 10 that is the subject of the invention. The hinge 10 includes a first bracket 12 and a second bracket 14. The first and second brackets 12, 14 are disposed a distance from one another. As will be discussed in greater detail below with respect to FIGS. 14 and 15, the first and second brackets 12, 14 move with respect to one another to enable a pivoted, hinged operation.

As illustrated, for this contemplated configuration, the first and second brackets 12, 14 are essentially oval-shaped. It is noted that the oval shapes are considered to represent one possible configuration for the first and second brackets 12, 14. As should be appreciated by those skilled in the art, the first and second brackets 12, 14 may take any suitable shape without departing from the scope of the invention.

As also illustrated in FIG. 1, the hinge 10 includes a connecting stem 16 that extends between the first and second brackets 12, 14.

In the illustrated embodiments, the first and second brackets 12, 14 are contemplated to be constructed from a suitable metal or metal alloy. Stainless steel and aluminum are considered to be materials from which the first and second brackets 12, 14 may be constructed. These materials are considered for use with the invention because of their aesthetic appearance, their strength, and their resistance to corrosion, especially in a marine environment, which is one possible environment where the hinge 10 of the invention may be employed.

As should be appreciated by those skilled in the art, however, the first and second brackets 12, 14 may be constructed from any alternative material. It is contemplated, for example, that the first and second brackets 12, 14 may be constructed from a plastic, a composite material, or an alloy, among other possibilities too numerous to list here.

Since corrosion resistance is one consideration for the bracket 10 in a marine environment, it is contemplated that the brackets 12, 14 may be constructed from a material that is resistant to corrosion. Alternatively, the material may be coated or treated to increase resistance to environmental degradation.

It is also contemplated that the first and second brackets 12, 14 may be exposed for extended periods of time to sunlight. As a result, it is contemplated that the first and second brackets 12, 14 may be made from a material (or coated with a material) that resists degradation and fading when exposed to sunlight, including ultraviolet light.

As should be immediately apparent, the precise selection of materials for the first and second brackets 12, 14 is not critical to the invention.

As illustrated throughout the figures, the connecting stem 16 includes a protrusion 18 at one end. In the illustrated embodiment, the protrusion 18 is spherical and, therefore, will be referred to herein as a spherical protrusion 18. As should be appreciated by those skilled in the art, however, the protrusion 18 need not be spherical to practice the invention. It is contemplated, for example, that ellipsoid, oval, or cylindrical protrusions may be employed, among other shapes.

In the assembled condition illustrated in FIGS. 1-6, the spherical protrusion 18 is disposed within an insert 22 that is positioned within a channel 24 in the first bracket 12. A stem adjustment element 20 also is illustrated. The stem adjustment element 20 is a hexagonal indentation in the end of the spherical protrusion 18.

In the illustrated embodiment, the spherical protrusion 18 is integrally formed with the connecting stem 16. The term “integral” is intended to encompass at least two alternatives, among others. In the first instance, “integral” is intended to encompass the formation of the connecting stem 16 and the spherical protrusion 18 as a unitary structure. In the second instance, the term “integral” refers to the separate manufacture and subsequent connection of the connecting stem 16 and the spherical protrusion 18. In this contemplated embodiment, the spherical protrusion 18 may be welded to the connecting stem, for example. Other attachment schemes also are contemplated to fall within the scope of the invention, as should be appreciated by those skilled in the art.

For purposes of simplifying a discussion of the hinge 10, it is noted that the combination of the connecting stem 16 and the spherical protrusion 18 may be referred to collectively as the connecting stem 16 depending upon the particular context.

It is contemplated that the connecting stem 16 and spherical protrusion 18 are manufactured from the same material (or materials) as the first and second brackets 12, 14. It is also contemplated that the same material may be used to construct the connecting stem 16 and the first and second brackets 12, 14, at least for appearance (i.e., aesthetic) purposes.

Alternatively, the various elements that comprise the hinge 10 may be made from different materials, as necessary or as desired. For example, the spherical protrusion 18 may be made from polytetrafluoroethylene to facilitate rotation of the first and second brackets 12, 14 with respect to one another around the spherical protrusion 18.

The stem adjustment element 20 is illustrated as a hexagonal indentation in the end of the spherical protrusion 18. Specifically, rotation of the connecting stem 16 via the stem adjustment mechanism 20 alters the extent to which the connecting stem 16 protrudes from the second bracket 14. Rotation of the connecting stem 16 is made possible by the stem adjustment element 20, as should be apparent to those skilled in the art.

In the illustrated embodiment, the stem adjustment element 20 is intended to receive a suitable wrench, such as an Allen Wrench or its equivalent. As should be immediately apparent, other adjustment elements may be employed. For example, the spherical protrusion 18 may be manufactured to receive a Phillips head or regular screw driver. It is also contemplated that the adjustment element may protrude from the end of the protrusion 18 without departing from the scope of the invention.

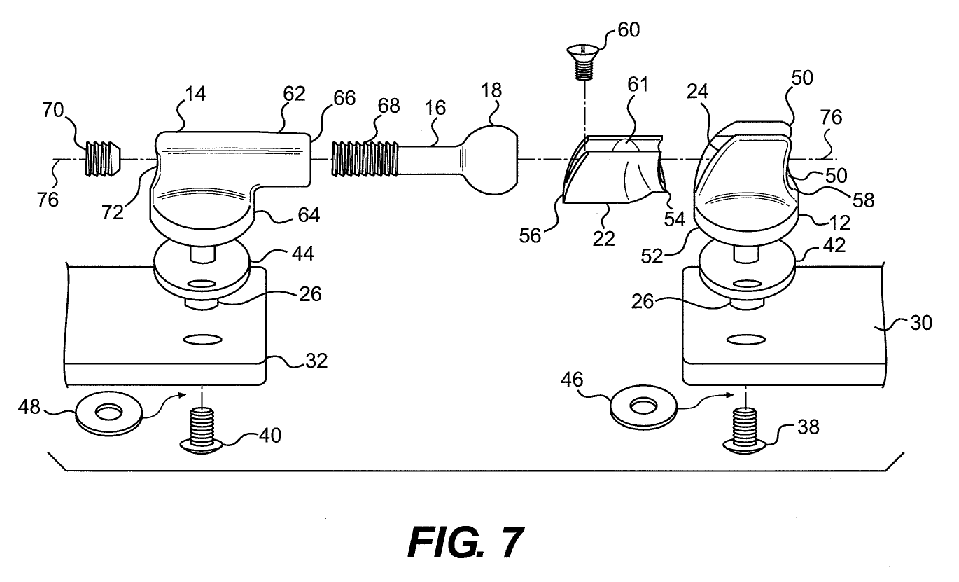

The insert 22, which is detailed in FIG. 7, is positioned within a channel 24 in the first bracket 12. The insert 22 is contemplated to be made from a material such as plastic, polytetrafluoroethylene, oil-impregnated metal, or a suitable substitute. The insert 22 is provided between the spherical protrusion 18 and the channel 24 in the first bracket 12 to facilitate rotation of the first bracket 12 with respect to the second bracket 14. The insert 22 is intended to permit a smooth, pivotal connection between the spherical protrusion 18 and the channel 24. The insert 22 is expected to reduce or eliminate the occurrence of binding and/or squeaking which may otherwise occur.

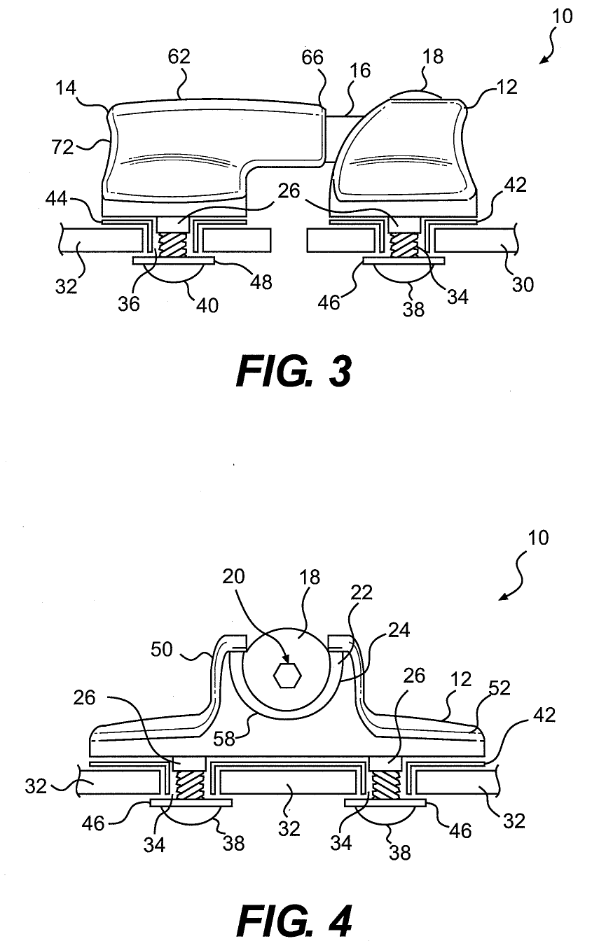

FIGS. 3, 4, and 6, which are side elevational views of the hinge 10, illustrate protrusions 26 that extend from lower surfaces 28 of the first and second brackets 12, 14. The protrusions 26 extend into first and second substrates 30, 32 on which the first and second brackets 12, 14, respectively, are mounted, when installed. The protrusions 26 are inserted into complimentary first and second recesses 34, 36 in the first and second substrates 30, 32. First and second fasteners 38, 40 are inserted through the first and second substrates 30, 32 and engage the protrusions 26. The first and second fasteners 38, 40 affix the first and second substrates 30, 32 to the first and second brackets 12, 14.

In the illustrated embodiments, the first and second fasteners 38, 40 are screws. As should be appreciated by those skilled in the art, other fasteners may be used without departing from the scope of the invention.

The protrusions 26 are contemplated to be integrally formed with the first and second brackets 12, 14. As such, the protrusions 26 are contemplated to be made from the same material (or materials) as the first and second brackets 12, 14.

In an alternate design, it is contemplated that the bracket 12, 14 may not include any protrusions 26 at all. As such, the protrusions 26 are not required to practice the invention.

The substrates 30, 32 may be any suitable materials that would be expected for a typical cabinet or door, for example. In the illustrated embodiments, the substrates 30, 32 are both glass and are intended to secure a glass door to a glass structure, such as a portion of a windshield. However, the first and second substrates 30, 32 may be made from any other material such as wood, fiberglass, composite materials, or metal, for example. Moreover, the first and second substrates 30, 32 need not be the same material to practice the invention.

In the illustrated example, since the first and second substrates 30, 32 are glass, the hinge 10 is provided with first and second liners 42, 44 that are positioned between the first and second brackets 12, 14 and the first and second substrates 30, 32. In addition, first and second washers 46, 48 are positioned between the first and second substrates 30, 32 and the first and second fasteners 38, 40. The liners 42, 44 and the washers 46, 48 are provided to reduce the potential for cracking of the substrates 30, 32.

The liners 42, 44 and washers 46, 48 are contemplated to be made from a suitable plastic, silicone, or rubber material, among others. In particular, the liners 42, 44 and the washers 46, 48 are contemplated to be made from a compressible material that provides at least a modest cushion between the brackets 12, 14 and the fasteners 38, 40. This is expected to reduce the potential for cracking, especially when one or both of the substrates 30, 32 are made of glass (or other fragile material).

It is contemplated that the hinge 10 may be installed without the liners 42, 44 or the washers 46, 48 without departing from the scope of the invention.

The hinge 10 will now be described with reference to the exploded perspective view in FIG. 7. Various elements that make up the hinge 10 are shown in a positional relationship with respect to one another.

As noted above the first bracket 12 is positioned atop the first liner 42 on the first substrate 30. The first bracket 12 is affixed to the first substrate 30 via one or more first fasteners 38. As illustrated in FIG. 4, two fasteners 38 are used. Of course, as should be appreciated by those skilled in the art, a larger number or a fewer number of the first fasteners 38 may be used without departing from the scope of the invention.

The first bracket 12 includes two upwardly sweeping arms 50 that define the channel 24 therebetween. The arms 50 extend upwardly from a base 52. In the illustrated embodiments, the arms 50 are curved structures. As should be appreciated by those skilled in the art, the arms 50 need not be curved to practice the invention.

The insert 22 slides into the channel 24 defined in the first bracket 12. The insert 22 has a generally C-shaped cross-section with a narrow first end 54 and a wider second end 56. The spherical protrusion 18 is inserted into the wider second end 56 and is prevented from passing all of the way through the channel by the narrower first end 54. In addition, the protrusion 18 is prevented from sliding all of the way through the channel 24 by a lip 58 formed on the first bracket 12.

A retainer 60, such as a screw, affixes the liner 22 to the first bracket 12. The retainer (or fastener) 60 also may act as a stop to prevent the spherical projection 18 from sliding out of the liner 22 and the channel 24 after the first bracket 12 is installed on the first substrate 30.

However, it is contemplated that the retainer 60 will not act as a stop. Instead, it is contemplated that the insert 22 will be constructed from a flexible or semi-flexible material that includes a spherical indentation 61. During assembly, it is contemplated that the insert 22 will be pressed into engagement with the spherical protrusion 18 until the spherical protrusion seats within the spherical indentation 61. Once the insert 22 is affixed into the channel 24 via the retainer 60, the arms 50 provide a rigid surface to prevent the insert 22 from expanding and, therefore, releasing the spherical protrusion 18 from the indentation 61. As a result, once the insert 22 is secured within the channel 24, the spherical protrusion 18 is securely fastened within the channel 24.

As should be apparent to those skilled in the art, the insert 22, once secured in the channel 24, acts as a bearing for the spherical protrusion 18. The insert 22 may be manufactured from any number of materials including, but not limited to, polytetrafluoroethylene, oil impregnated metal, bronze, or any suitable alternative.

It is also contemplated that the insert 22 may be omitted altogether. In such an embodiment, the spherical protrusion 18 may be made from one or more materials including, but not limited to, polytetrafluoroethylene, oil impregnated metal, bronze, or any suitable alternative. In this embodiment, it is contemplated that the retainer 60 may assist to prevent the spherical protrusion 18 from being withdrawn from the channel 24. Other retainers also may be used without departing from the scope of the invention.

The second bracket 14 includes a threaded portion 62 that is connected integrally to a base 64. A first end 66 of the threaded portion 62 receives a threaded end 68 of the connecting stem 16. A locking member 70 is inserted into a second end 72 of the threaded portion 62. In the illustrated embodiments, the locking member 70 is a screw that abuts the threaded end 68 of the connecting stem 16 to maintain the connecting stem 16 in a fixed position within the second bracket 14.

To adjust the position of the locking member 70 within the threaded portion, the locking member 70 is provided with a locking member adjustment element 74. The locking member adjustment element 74 is a hexagonal indentation adapted to receive a wrench, such as an Allen wrench. As with the stem adjustment element 20, the locking member adjustment element 74 may take alternative forms without departing from the scope of the invention.

In one contemplated alternative, it is contemplated that the second bracket might include a threaded pin that extends from the threaded portion 62. In such an embodiment, the connecting stem 16 may be a tapped cylinder that engages the threaded portion extending from the threaded portion 62 of the second bracket 14.

In still another contemplated embodiment, the locking screw 70 may be omitted. Instead, the threaded portion 62 may be provided with a plurality of holes into which a pin may be inserted. The pin would then act as a stop to prevent movement of connecting stem 16.

With respect to adjustment of the first bracket 12 with respect to the second bracket 14, it is also contemplated that the insert 22 may be adjusted with respect to its position within the channel 24. The retainer 60 may be used in this contemplated embodiment to adjust the position of the insert 22.

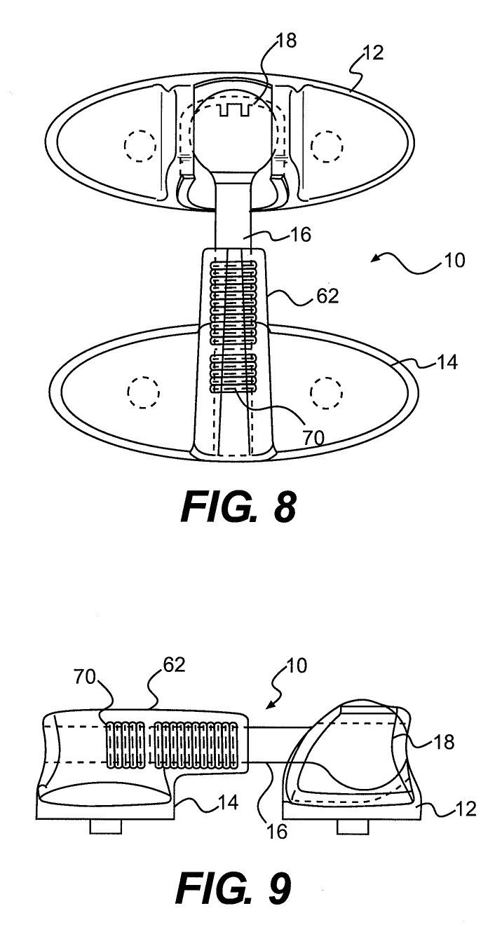

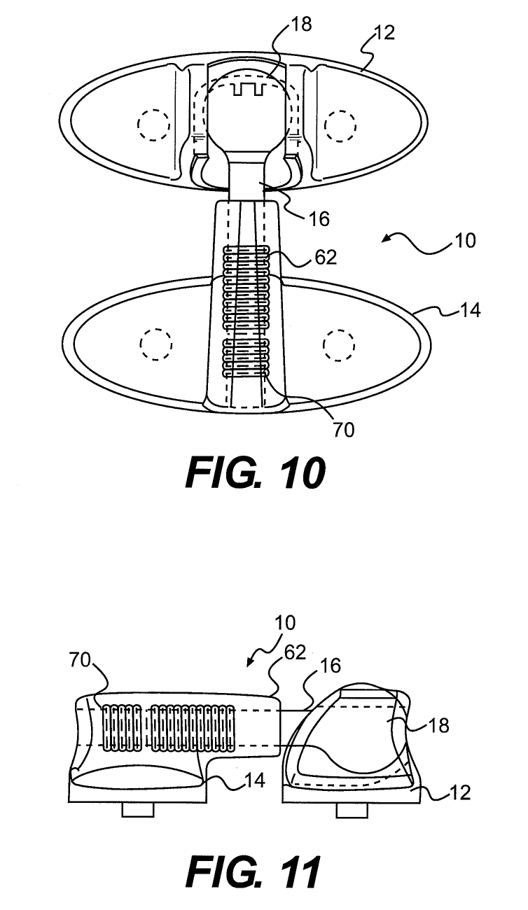

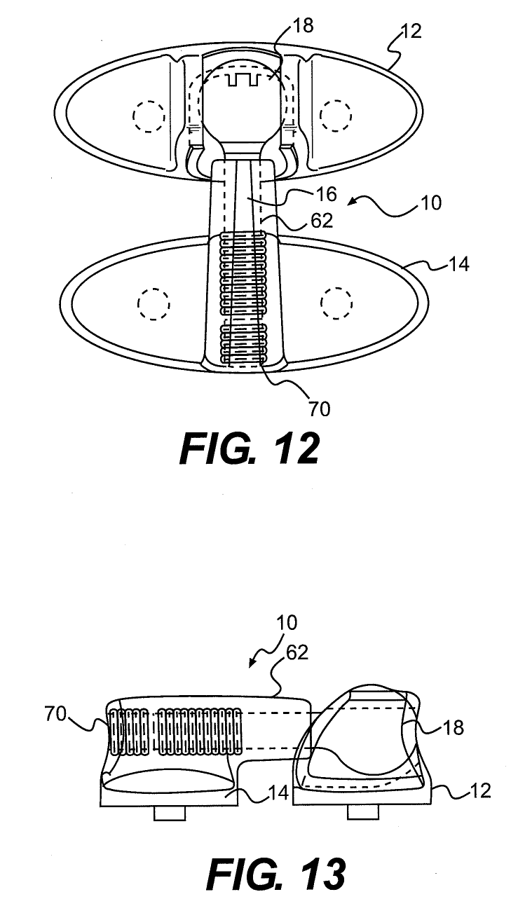

FIGS. 8-13 provide top plan and right side views of the hinge 10 of the invention. These views illustrate the hinge 10 in a transparent format so that the juxtapositions of the elements with respect to one another may be more readily appreciated. In addition, FIGS. 8-13 illustrate three different positions for the connecting stem 16. In FIGS. 8-9, the connecting stem 16 has been extended so that the hinge presents a wide stance. In FIGS. 10-11, the connecting stem 16 has been adjusted to present a moderate stance. In FIGS. 12-13, the connecting stem 16 has been adjusted so that the hinge 10 presents a narrow stance between the first and second brackets 12, 14.

FIGS. 8-13 illustrate how the connecting stem 16 may be adjusted to provide a significant degree of flexibility when the hinge 10 is installed in a particular environment.

It is noted that the common or central axis for the hinge 10 is labeled 76 in FIG. 7. In FIG. 7, the central axis of the first bracket 12 coincides with the central axis of the second bracket 14. In other words, the axes are co-linear and are designated with reference numeral 76. As should be appreciated by those skilled in the art, the axes need not be co-linear to practice the invention.

FIG. 14 provides a side view illustration of the hinge 10 of the invention, showing the second bracket 14 rotating through a full rotation with respect to the first bracket 12. The rotation of the second bracket 14 is indicated by the arrow 78. As should be apparent, the axis of rotation is perpendicular to the central axis 76. Moreover, the pivot axis passes through the protrusion 18. As should be apparent to those skilled in the art, the axis of rotation need not be perpendicular to the central axis 76.

FIGS. 15-17 are provided for clarification. These three figures provide perspective illustrations of the rotation of the second bracket 14 around the spherical protrusion 18, as illustrated in FIG. 14. In FIG. 15, the first and second brackets 12, 14 are in an initial state, which would occur when a door is closed, for example. FIG. 16 illustrates the position of the second bracket 14 after the second bracket has traveled through approximately one half of its travel distance. This is equivalent to about 90° of rotation. FIG. 17 shows the second bracket 14 in a position after it has traveled through its full rotation around the protrusion 18. This is equivalent to about 180° of rotation. This state exists when a door is fully opened, for example.

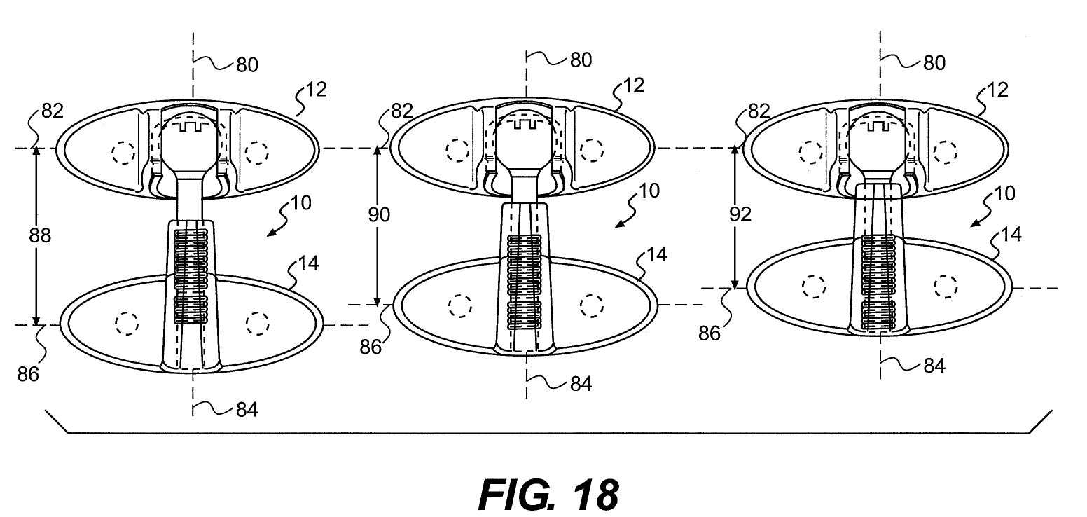

FIG. 18 is an illustration of three hinges 10 shown in one possible arrangement for a door on a boat, for example.

In FIG. 18, the three hinges 10 are shown with the respective connecting stems 16 in various positions. The hinge 10 on the left of the illustration shows the hinge 10 with a wide stance between the first and second brackets. The center hinge 10 illustrates a moderate stance. The right-hand hinge 10 illustrates a narrow stance.

With respect to the three hinges 10, the stances are identified with respect to the distances between the first and second brackets 12, 14.

To facilitate a discussion of further aspects of the hinge of the invention 10, several axes of the hinge 10 are now identified. Specifically, the first bracket 12 defines a first central axis 80 that is parallel to the axis of the channel 24 defined thereby. The first bracket 12 also defines a first lateral axis 82 that is perpendicular to the first central axis 80. Similarly, the second bracket 14 defines a second central axis 84 that runs parallel to the threaded bore in the threaded end 68. The second bracket 14 also defines a second lateral axis 86 that is perpendicular to the second central axis 84. For simplicity, the first lateral axis 82 and the second lateral axis 86 are defined by the widest portions of the bases 52, 64. Of course, this is not required to practice the invention.

In FIG. 18, the distance between the first lateral axis 82 and the second lateral axis 86 defines the wide, moderate, or narrow stances of the hinges 10. For the wide stance, the distance is indicated by the reference numeral 88. For the moderate stance, the distance is designated 90. For the narrow stance, the distance is labeled 92.

As is apparent in this illustration, the three spherical protrusions are aligned along a common rotational axis, which coincides with the first lateral axes 82 of each of the hinges 10. The lateral axes 86 of the second brackets, however, are not aligned. Despite this misalignment of the axes 82 and 86, the three hinges 10 will cooperate to permit the attached door to open. As noted, this is one of the features presented by the hinge 10 of the invention.

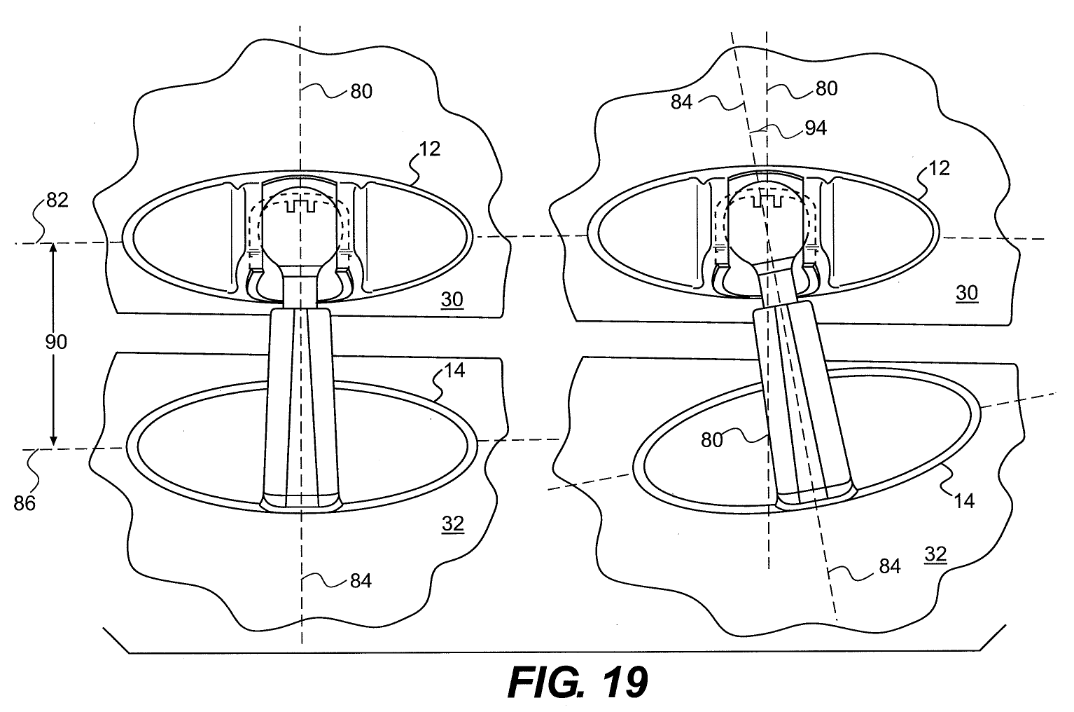

It is noted that the hinges 10 also may be installed such that they are not angularly aligned with one another, at least within a certain range of freedom. This arrangement is illustrated in FIG. 19. Since the spherical protrusions 18 provide the pivot point for the first and second brackets 12, 14 to rotate with respect to one another, the axes of the connecting stems 16 for the individual hinges 10 need not be precisely parallel with one another in order for the hinges to cooperate with one another. This aspect of the hinges 10 permits the hinges 10 to be connected to non-linear substrates 30, 32 while continuing to provide a hinged connection. In addition, this aspect of the hinges 10 permits the substrates 30, 32 to be disposed adjacent to one another without being precisely aligned with respect to one another.

FIG. 19 illustrates two hinges 10 that are disposed on first and second substrates 30, 32. The connecting stem 16 and the second bracket 14 of the right-hand hinge 10 is displaced from the orientation of the left hand hinge 10 such that the first central axis 80 and the second central axis 84 are disposed at an angle 94 from one another. As should be apparent the angle 94 is not expected to have any impact on the operation of the hinge 10. In less frequent example, it is expected that the angle 94 may be 90° or more. However, in a more common example, it is expected that the angle 94 may be less than about 45°. In an alternative embodiment, the angle 94 may be less than about 25°. In still another contemplated embodiment, the angle 94 may be less than about 15°. Other variations are also contemplated to fall within the scope of the invention.

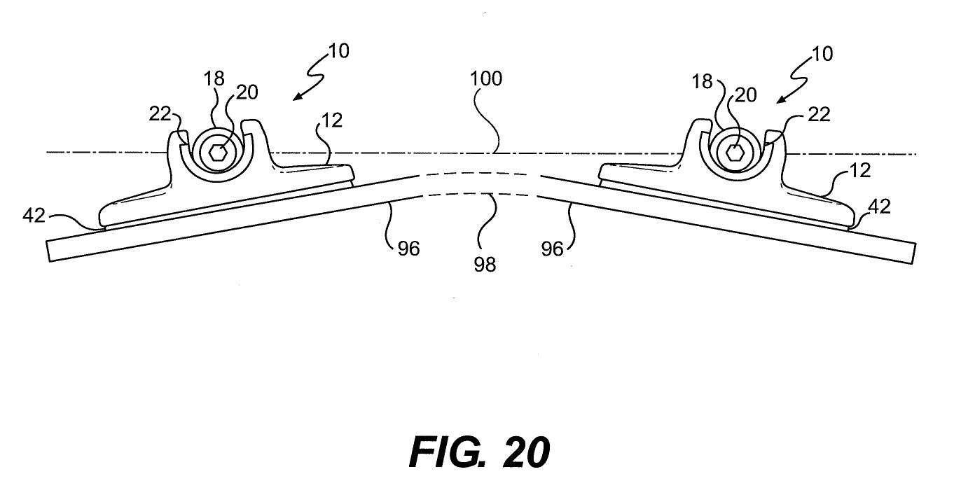

FIGS. 20-22 are provided, among other reasons, to illustrate how the hinge 10 of the invention may be employed when connected to a substrate 96, such as a door. The substrate 96 may be a non-linear (or non-planar) surface including a curved portion (or portions), as indicated by the connector portion 98 in dotted lines. The curved surface of the connector portion 98 may take any suitable shape and is shown in dotted line format to indicate this potential.

FIG. 20 is an end view illustration, showing two hinges 10 connected to the substrate 96. As may be appreciated, in this view, only the first brackets 12 for each hinge 10 are visible since the second brackets 14 are obscured from view by the first brackets 12. The dotted centerline in this illustration is the pivot axis 100 common to the two hinges 10. The pivot axis 100 is the axis around which the hinges 10 and the substrate 96 rotate. As should be apparent, the second brackets 14 are expected to be secured to an immovable surface.

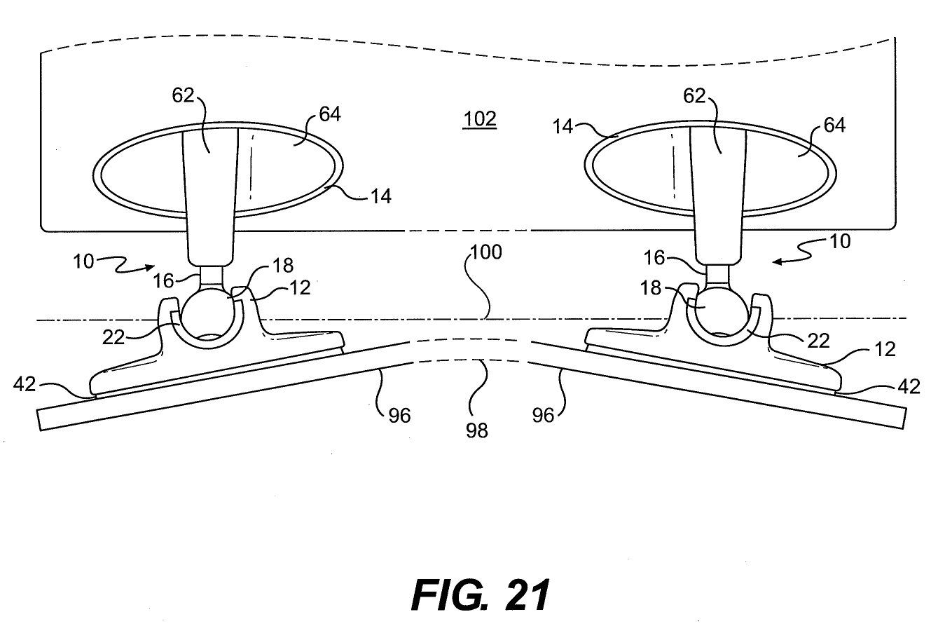

FIG. 21 is a plan view of the same hinges 10 illustrated in FIG. 20. In this view, the immovable surface 102, to which the second brackets 14 are secured, is illustrated. Here, the hinges 10 have been rotated by 90° from the orientation illustrated in FIG. 20. It is noted that the terms immovable surface 102 and substrate 96 are intended merely as references. As should be appreciated by those skilled in the art, the immovable surface 102 is not intended to refer to a fixed surface only. To the contrary, the positions of the first and second brackets 12, 14 may be reversed. In other words the first brackets 12 may be affixed to the immovable surface 102 while the second brackets 14 are affixed to the substrate 96.

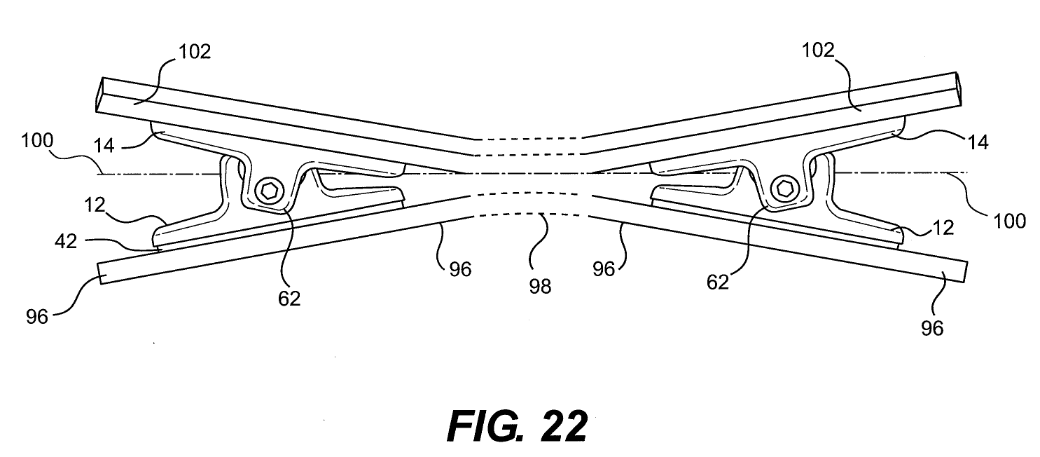

FIG. 22 is an end view of the hinges 10 shown in FIGS. 20 and 21. In this view, the hinges 10 have been rotated 180° from their original orientations shown in FIG. 20.

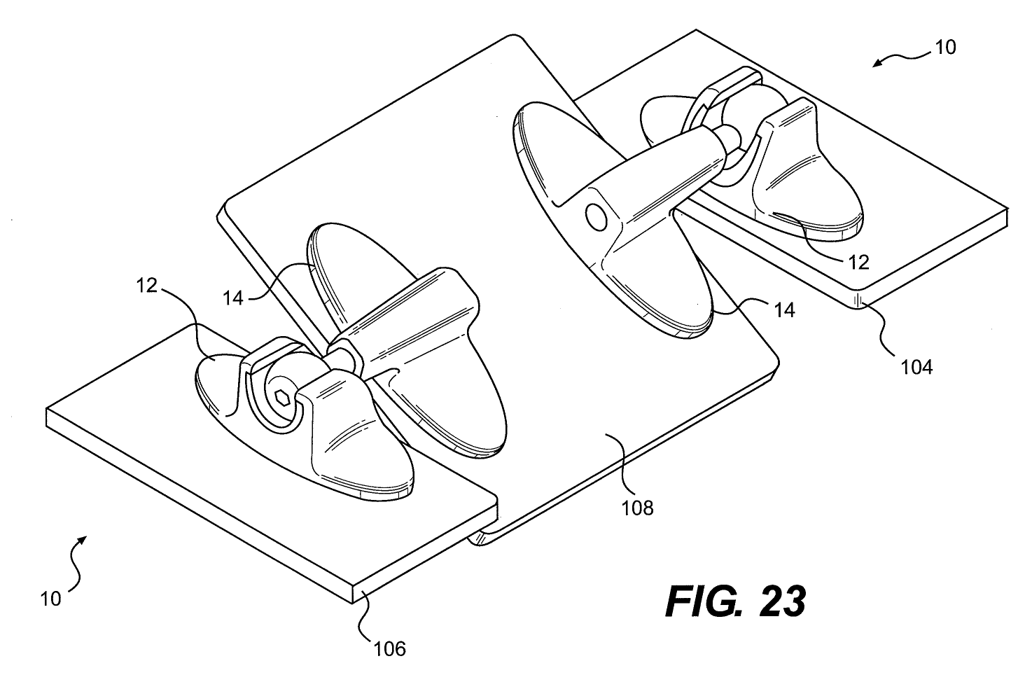

FIG. 23 illustrates another configuration of two hinges 10. Here, the hinges 10 oppose one another along a pivot axis. In the configuration shown, the first brackets 12 of the hinges 10 are affixed to immovable surfaces 104, 106. The second brackets 14 are affixed to a substrate 108 that moves with respect to the immovable substrates 102, 104.

As should be apparent to those skilled in the art, this orientation is not the only one possible for the hinges. For example, it is contemplated that the first brackets 12 may be affixed to the substrate 108 and the second brackets may be affixed to the immovable surfaces 102, 104. Alternatively still, the hinges 10 may be aligned such that the first bracket 12 from one of the hinges 10 is affixed to the substrate 108 while the second bracket 14 of the other of the hinges 10 is attached to the substrate 108. Still other variations are possible.

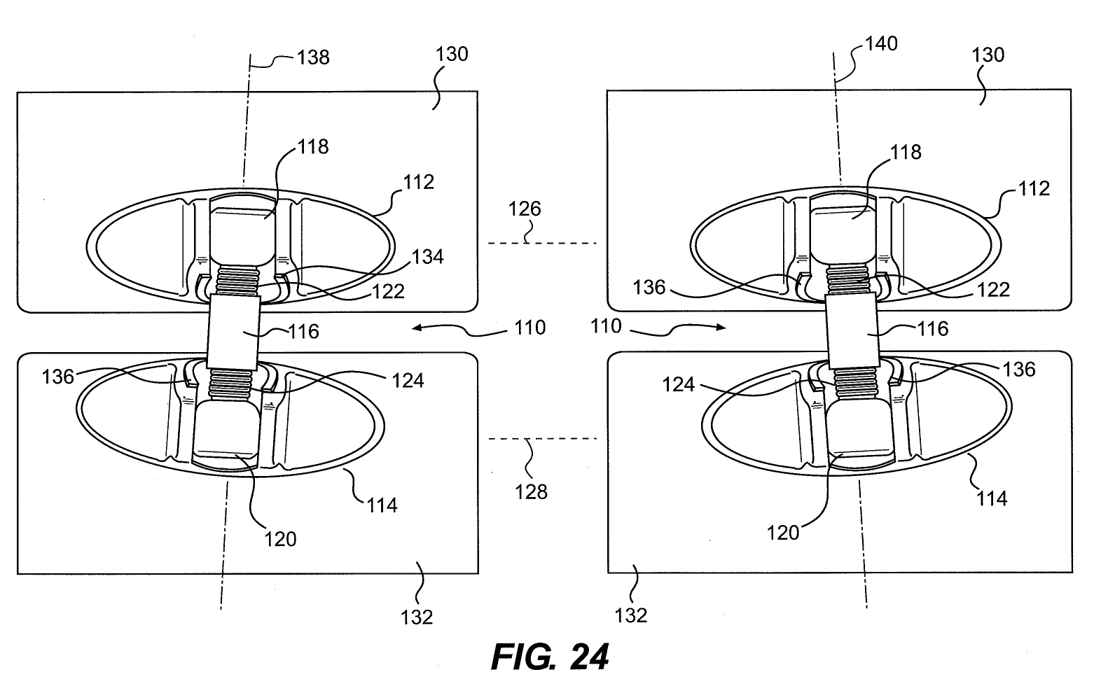

FIG. 24 illustrates a second embodiment of a hinge 110. In this embodiment, the hinge 110 includes a first bracket 112 and a second bracket 114. The first and second brackets 112, 114 in this embodiment are the same as the first brackets 12 in the first embodiment illustrated in FIGS. 1-23.

The first and second brackets 112, 114 are connected to one another via a connecting stem 116. In this embodiment, the connecting stem 116 includes spherical protrusions 118, 120 at either end. The connecting stem also includes first and second threaded portions 122, 124 onto which the spherical protrusions 118, 120 are disposed. The threaded portions 122, 124 permit adjustment of the locations of the spherical protrusions 118, 120 thereon, thereby permitting adjustment of the distance between the first and second brackets 112, 114.

In operation, as should be apparent to those skilled in the art, the hinges 110 are double-jointed, meaning that they pivot about two pivot axes, a first pivot axis 126 and a second pivot axis 128. This affords the hinges 110 with a greater flexibility in operation. Specifically, by employing a double-jointed approach, a door may be opened up to 360° from its initial orientation. In other words, the first pivot axis 126 permits up to 180° of initial rotation. The second pivot axis 128 permits up to a second 180° of rotation. Combined, the two pivot axes 126, 128 permits up to 360° of rotation.

It is noted that the first brackets 112 are mounted on an immovable surface 130. The second brackets 114 are mounted on a movable substrate 132.

As in the hinge 10 of the prior embodiment, the spherical protrusions 118, 120 are intended to be secured in the first and second brackets 112, 114 via first and second inserts 134, 136, respectively. The inserts 134, 136 are intended to be constructed and to function in the same fashion as the insert 22.

It is noted that this second embodiment of the hinge 110 may be used in much the same manner as the hinge 10 in the prior embodiments.

The longitudinal axes 138, 140 of the hinges 110 may be positioned so that they intersect one another.

Alternatively, the hinges 110 may be positioned so that the axes 138, 140 are parallel. One problem that may be introduced with a parallel arrangement is that the substrate 132 will tend to droop with respect to the immovable surface 130.

However, it is understood that the substrate 132 will be held in position, without a droop, if the axes 138, 140 intersect one another. The intersection of the axes 138, 140 creates a geometrical arrangement that resists droop.

As should be immediately apparent, a gap between the immovable surface 130 and the substrate 132 may be adjusted by adjusting the positions of the protrusions 118, 120 on the connecting stems 116. In addition, it is contemplated that one or both of the brackets 112, 114 may be shifted laterally with respect to one another to adjust the gap between the substrate 132 and the immovable surface 130. In this adjustment scheme, the axes 138, 140 are intentionally skewed with respect to one another to achieve the appropriate gap between the immovable surface 130 and the substrate 132.

While not illustrated, it is also contemplated that one or all of the brackets 12, 14, 112, 114 may be modified to act as a latch in addition to acting as a bracket 12, 14, 112, 114. In this embodiment, it is contemplated that that the bracket 12, 14, 112, 114 may act first as a hinge to permit a door to be opened. Then, if desired, the user may be able to release the door from the bracket 12, 14, 112, 114, as needed. In this contemplated embodiment, the arms 50 may be arranged to accept the spherical protrusion 18 from a top end rather than axially in the channel 24.

Other variations of the latch embodiment also are contemplated. For example, if four latch-type hinges were employed to secure a panel to a fixed structure (immovable surface), the four latch-type hinges could permit the panel to be opened as a door along multiple axes. Alternatively, the four latch-type hinges would permit the panel to be removed altogether.

In addition to the embodiments discussed above, it is also contemplated that the brackets 12, 14, 112, 114 may be used as fixed panel mounts. The adjustability of the brackets 12, 14, 112, 114 would permit for compensate for misalignment of the panels.

As noted above, the embodiments described above are intended to be illustrative of the breadth of the scope of this invention. As should be appreciated by those skilled in the art, there are numerous variations and equivalents to the embodiments described and illustrated herein. Those variations and equivalents are intended to fall within the scope of this invention.

What is claimed is:

1. A hinge, comprising:
a first bracket adapted to be attached to a first substrate, the first bracket having a channel defining a first central axis and defining a first lateral axis perpendicular to the first central axis;
a second bracket adapted to be attached to a second substrate, the second bracket defining a second central axis and a second lateral axis perpendicular to the second central axis, wherein the first lateral axis and the second lateral axis are disposed a distance from one another;
a connecting stem pivotally connecting the first bracket to the second bracket;
a protrusion disposed at one end of the connecting stem, the protrusion being disposed within the channel defined by the first bracket; and
an adjustable connection between the connecting stem and the second bracket,
wherein the adjustable connection permits adjustment of the distance between the first and the second lateral axes.

2. The hinge of claim 1, wherein the first central axis and the second central axis are co-linear.

3. The hinge of claim 1, wherein the first central axis and the second central axis are angled with respect to one another.

4. The hinge of claim 1, wherein the first bracket includes two upwardly extending arms that define the channel therebetween.

5. The hinge of claim 1, further comprising:
an insert disposed within the channel to facilitate movement of the protrusion within the channel.

6. The hinge of claim 5, wherein the protrusion is retained within an indentation formed in the insert.

7. The hinge of claim 6, further comprising:
a retainer to affix the insert within the channel.

8. The hinge of claim 1, wherein the insert comprises polytetrafluoroethylene.

9. The hinge of claim 1, wherein protrusion is spherical.

10. The hinge of claim 1, wherein the second bracket comprises a threaded portion and the adjustable connection comprises a threaded end on the connecting stem that engages the threaded portion of the second bracket.

11. The hinge of claim 10, further comprising a locking member that retains the connecting stem to maintain the distance between the first and the second lateral axes.

12. A hinge system, comprising:
a first hinge comprising
a first bracket adapted to be attached to a first substrate, the first bracket having a first channel defining a first central axis and defining a first lateral axis perpendicular to the first central axis,
a second bracket adapted to be attached to a second substrate, the second bracket defining a second central axis and a second lateral axis perpendicular to the second central axis, wherein the first lateral axis and the second lateral axis are disposed a first distance from one another,
a first connecting stem pivotally connecting the first bracket to the second bracket,
a first protrusion disposed at one end of the first connecting stem, the first protrusion being disposed within the first channel defined by the first bracket, and
a first adjustable connection between the first connecting stem and the second bracket, wherein the first adjustable connection permits adjustment of the first distance between the first and the second lateral axes; and
a second hinge comprising
a third bracket adapted to be attached to the first substrate, the third bracket having a second channel defining a third central axis and defining a third lateral axis perpendicular to the third central axis,
a fourth bracket adapted to be attached to the second substrate, the fourth bracket defining a fourth central axis and a fourth lateral axis perpendicular to the fourth central axis, wherein the third lateral axis and the fourth lateral axis are disposed a second distance from one another,
a second connecting stem pivotally connecting the third bracket to the fourth bracket,
a second protrusion disposed at one end of the second connecting stem, the second protrusion being disposed within the second channel defined by the third bracket, and
a second adjustable connection between the second connecting stem and the fourth bracket, wherein the second adjustable connection permits adjustment of the second distance between the third and the fourth axes;
wherein the first hinge and the second hinge are disposed a third distance from one another.

13. The hinge system of claim 12, wherein at least one of the first central axis is angled with respect to the second central or the third central axis is angled with respect to the fourth central axis.

14. The hinge system of claim 12, wherein the first distance does not equal the second distance.

15. The hinge system of claim 12, wherein at least one of the first and second substrates defines a non-linear surface.

16. The hinge system of claim 12, wherein at least one of the first and second substrates defines a curved surface.

17. A hinge, comprising:
a first bracket adapted to be attached to a first substrate, the first bracket having a first channel defining a first central axis and defining a first lateral axis perpendicular to the first central axis;
a second bracket adapted to be attached to a second substrate, the second bracket having a second channel defining a second central axis and defining a second lateral axis perpendicular to the second central axis;
a connecting stem pivotally connecting the first bracket to the second bracket;
a first protrusion adjustably disposed on a first end of the connecting stem, the first protrusion being retained within the first channel; and
a second protrusion adjustably disposed on a second end of the connecting stem, the second protrusion being retained within the second channel;
wherein adjustment of one or both of the first and second protrusions on the connecting stem adjusts a distance between the first lateral axis and the second lateral axis.

18. The hinge of claim 17, wherein the first lateral axis and the second lateral axis are angled with respect to one another when the hinge is installed for operation.

19. A hinge system, comprising:
a first hinge comprising
a first bracket adapted to be attached to a first substrate, the first bracket having a first channel defining a first central axis and defining a first lateral axis perpendicular to the first central axis,
a second bracket adapted to be attached to a second substrate, the second bracket having a second channel defining a second central axis and defining a second lateral axis perpendicular to the second central axis,
a first connecting stem pivotally connecting the first bracket to the second bracket,
a first protrusion adjustably disposed on a first end of the first connecting stem, the first protrusion being retained within the first channel, and
a second protrusion adjustably disposed on a second end of the first connecting stem, the second protrusion being retained within the second channel; and
a second hinge comprising
a third bracket adapted to be attached to the first substrate, the third bracket having a third channel defining a third central axis and defining a third lateral axis perpendicular to the third central axis,
a fourth bracket adapted to be attached to the second substrate, the fourth bracket having a fourth channel defining a fourth central axis and defining a fourth lateral axis perpendicular to the fourth central axis,
a second connecting stem pivotally connecting the third bracket to the fourth bracket,
a third protrusion adjustably disposed on a first end of the second connecting stem, the third protrusion being retained within the third channel, and
a fourth protrusion adjustably disposed on a second end of the second connecting stem, the fourth protrusion being retained within the fourth channel;
wherein adjustment of one or both of the first and second protrusions on the first connecting stem adjusts a first distance between the first lateral axis and the second lateral axis,
wherein adjustment of one or both of the third and fourth protrusions on the second connecting stem adjusts a second distance between the third lateral axis and the fourth lateral axis.

20. The hinge system of claim 19, wherein at least one of the first and second substrates defines a non-linear surface.

21. The hinge system of claim 19, wherein at least one of the first and second substrates defines a curved surface.

22. The hinge system of claim 19, wherein the first and second connecting stems are oriented other than parallel to one another.
